(19) United States
(12) Patent Application Publication
(10) Pub. No.: US 2012/0151226 A1
(43) Pub. Date: Jun. 14, 2012

(54) APPARATUS AND METHOD FOR SELECTIVE BACK BIAS CONTROL OF AN INTEGRATED CIRCUIT

(75) Inventor: Darius D. Gaskins, Austin, TX (US)

(73) Assignee: VIA Technologies, Inc., Taipei (TW)

(21) Appl. No.: 12/965,888

(22) Filed: Dec. 12, 2010

(51) Int. Cl. G06F 1/26

(52) U.S. Cl. 713/300

(57) ABSTRACT

An apparatus for dynamically varying a bias voltage that is applied to a substrate of an integrated circuit is provided. The apparatus includes a selective bias generator and state table logic. The selective bias generator is disposed on the integrated circuit and is configured to generate one of a plurality of bias voltages according to a value received over a bias select bus, where the one of the plurality of bias voltages is applied to the substrate. The state table logic is coupled to the selective bias generator, and is configured to receive one or more power management states, and is configured to provide the value over the bias select bus, where the value includes one of a plurality of bias indications stored within the state table logic.

### CROSS-REFERENCE TO RELATED APPLICATIONS

This application is related to the following co-pending U.S. Patent Applications, each of which has a common assignee and common inventors.

| SERIAL | FILING | |
|---|---|---|
| NUMBER | DATE | TITLE |
| ( C̅N̅T̅R̅.̅2̅3̅2̅0̅) | Dec. 12, 2010 | APPARATUS AND METHOD FOR |
| | | ADAPTIVE BACK BIAS CONTROL |
| | | OF AN INTEGRATED CIRCUIT |
| ( C̅N̅T̅R̅.̅2̅5̅3̅0̅) | Dec. 12, 2010 | APPARATUS AND METHOD FOR |
| | | ADJUSTABLE BACK BIAS CONTROL |
| | | OF AN INTEGRATED CIRCUIT |

### BACKGROUND OF THE INVENTION

1. Field of the Invention

This invention relates in general to the field of microelectronics, and more particularly to an apparatus and method for controlling back bias voltage in an integrated circuit as a function of power control state.

2. Description of the Related Art

Computers continue to grow in capability and function. Whereas forty years ago a room full of electronic components was required to perform a simple computing task, a task one thousand times as complex can be performed by the processor inside a present day cell phone. This is truly amazing.

Developments in related fields such as device scaling, fabrication, and logic design have converged over these years to yield incredibly small, yet extremely powerful, devices. For example, a microprocessor produced in the 1970's utilized a 10 micrometer process and included an internal transistor count in the thousands. Now consider that a present day super scalar microprocessor is fabricated using a 45 nanometer process and includes over two billion transistors.

But these scaling and processing complexity gains have not come without cost. Among the many issues that designers have been forced to address over the years, device power consumption and the management thereof remains a persistent challenge. And perhaps the most demanding power constraints arise in the area of laptop computers because these systems must be capable of effectively executing a wide variety of very complex tasks while operating for a tolerable amount of time from a very limited power source. Consequently, a number of years ago, computer system designers began to develop power management schemes that enable theses computer system to extend the amount of time that they can operate on a limited source of power. In its simplest form, power management comprises turning off devices that are not needed at the time so that power is not wasted. This concept has been extended to the sub-device level as well. For instance, the well-known advanced configuration and power management interface (ACPI) calls for several progressive states of suspension of processing capability in a microprocessor, all the way from fully operational, through incremental states of hibernation (“sleep”), all the way to off. These states are typically managed and controlled via operating system software that senses operator input and the current processing environment, and directs the central processing unit (CPU) to enter and exit these various states as a function of processing requirements. As one skilled in the art will appreciate, power configuration and management schemes such as ACPI provide for battery lives that are an order of magnitude greater than that which has heretofore been provided. Taking the concept further, not only are logic blocks within a CPU turned on an off according to processing environment needs, but techniques are employed to vary the frequency and core voltages of processors according to these processing needs as well. A user is generally blithely unaware of the thousands of state, frequency, and voltage changes that are executed during a session in order to extend battery life.

Another aspect of power management—leakage mitigation—is equally as prevalent, but is seemingly unrelated to that discussed above. Simply stated, leakage is the amount of power a device consumes when it is powered up but idle. At the transistor level, leakage is measured in terms of how much power a CMOS gate consumes when it is off. And as one skilled in the art will appreciate, the scaling of CMOS technology devices increases the leakage problem as these devices are reduced in size, primarily due to shorter channel lengths. It is not uncommon today for leakage to account for a significant percentage of overall device power consumption.

There are several different extant techniques that are employed to mitigate leakage, one of which is substrate biasing. Essentially, a voltage is applied to the substrate of an integrated circuit die in order to decrease the amount of current that transistors in the off state draw. Substrate biasing is effective for leakage control, but in its present state it exhibits crude and sometimes problematic effects. As is appreciated by those skilled in the art, increasing the bias applied to a substrate also limits performance. The speed of a device is inversely proportional to the difference between the device's core operating voltage and its substrate bias voltage. And this inverse proportionality is not linear, but of a higher order. Furthermore, the amount of leakage that a device exhibits is not only a function of the difference between core operating voltage and substrate bias voltage, but also is a function (of a higher order) of the core operating voltage itself

The present inventor has noted that today's systems are limited because substrate bias voltage techniques utilize a single, fixed, substrate bias voltage, basically directed toward controlling device leakage at full operating voltage and frequency. Thus, when at maximum core voltage, the amount of power drawn by a processor is adequately controlled by this fixed bias voltage, when power state changes are mandated under operating system direction, such as lowering core operating voltage, the achievable performance of the processor is constrained.

Consequently, what is needed is a substrate biasing technique that is not limited to a single, fixed substrate bias voltage.

In addition, what is needed is a mechanism in a processor or integrated circuit that dynamically varies to optimize performance in the presence of power management direction and control.

Furthermore, what is needed is an apparatus and method for adapting the bias voltage applied to a substrate in accordance with power state changes such that leakage is adequately controlled but that also allows for operating frequency to be maximized at various power states.

### SUMMARY OF THE INVENTION

The present invention, among other applications, is directed to solving the above-noted problems and addresses other problems, disadvantages, and limitations of the prior art, thus providing a superior technique for precisely controlling substrate bias voltage in an integrate circuit.

In one embodiment, an apparatus for dynamically varying a bias voltage that is applied to a substrate of an integrated circuit is provided. The apparatus includes a selective bias generator and state table logic. The selective bias generator is disposed on the integrated circuit and is configured to generate one of a plurality of bias voltages according to a value received over a bias select bus, where the one of the plurality of bias voltages is applied to the substrate. The state table logic is coupled to the selective bias generator, and is configured to receive one or more power management states, and is configured to provide the value over the bias select bus, where the value includes one of a plurality of bias indications stored within the state table logic.

One aspect of the present invention contemplates an apparatus for dynamically varying a bias voltage that is applied to a substrate of an integrated circuit. The apparatus includes a microprocessor. The microprocessor has a selective bias generator and state table logic. The selective bias generator is disposed on the integrated circuit and is configured to generate one of a plurality of bias voltages according to a value received over a bias select bus, where the one of the plurality of bias voltages is applied to the substrate. The state table logic is coupled to the selective bias generator, and is configured to receive one or more power management states, and is configured to provide the value over the bias select bus, where the value includes one of a plurality of bias indications stored within the state table logic.

Another aspect of the present invention comprehends a method for dynamically varying a bias voltage that is applied to a substrate of an integrated circuit. The method includes storing a plurality of bias indications within state table logic disposed on the integrated circuit; via the state table logic, receiving one or more power management states, and providing a value over a bias select bus, where the value comprises one of the plurality of bias indications; and via a selective bias generator disposed on the integrated circuit, receiving the value over the bias select bus, generating one of a plurality of bias voltages according to the value, and applying the one of the plurality of bias voltages to the substrate.

Regarding industrial applicability, the present invention is implemented within a MICROPROCESSOR which may be used in a general purpose or special purpose computing device.

### BRIEF DESCRIPTION OF THE DRAWINGS

These and other objects, features, and advantages of the present invention will become better understood with regard to the following description, and accompanying drawings where:

FIG. 1 is a block diagram illustrating a present day technique for managing power within a computer system;

FIG. 2 is a block diagram depicting an apparatus for selective back bias control in an integrated circuit according to the present invention;

FIG. 3 is a block diagram featuring an apparatus for adaptive back bias control in an integrated circuit according to the present invention; and

FIG. 4 is a block diagram including an adjustable apparatus for adaptive back bias control in an integrated circuit according to the present invention.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

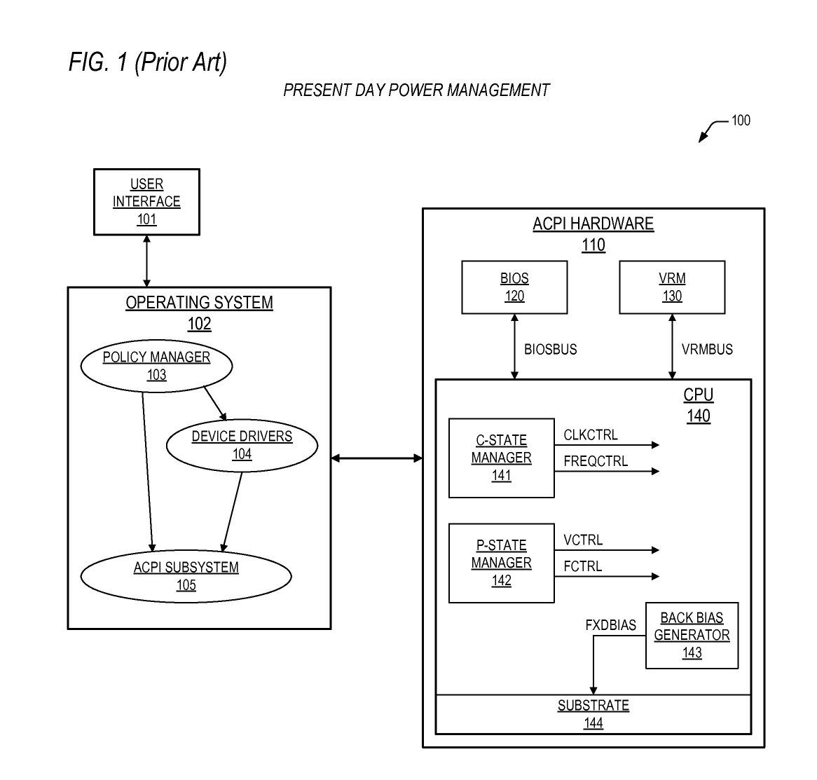

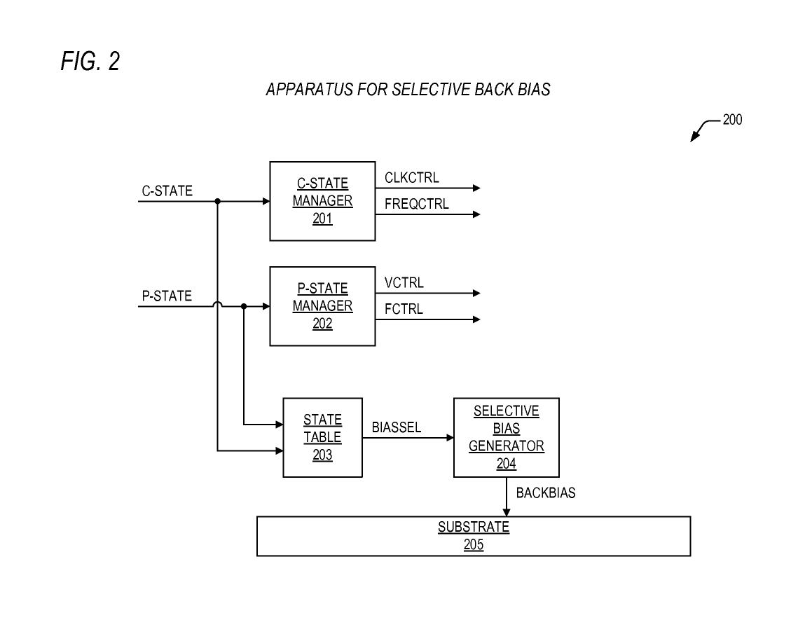

In view of the above background discussion on back bias voltage generation and associated techniques employed within present day integrated circuits for the mitigation of leakage, a discussion of the state of the art will be presented with reference to FIG. 1. Following this discussion, a presentation of the present invention will be presented with reference to FIGS. 2-4.

Referring now to FIG. 1, a block diagram 100 is presented illustrating a present day technique for managing power within a computer system. The diagram 100 includes advanced configuration and power management interface (ACPI) hardware 110 that is coupled to an operating system 102, which is typically disposed in a memory (not shown). The operating system 102 includes software modules 103-105 that include a policy manager 103, one or more device drivers 104, and an ACPI subsystem 105. The operating system 102 is coupled to ACPI hardware 110, which includes a basic input/output system (BIOS) 120, a voltage regulator module (VRM) 130, and a central processing unit (CPU) 140. The CPU 140, as an integrated circuit, is typically disposed on a substrate 144, typically of either P or N material, and includes a C-state manager 141, a P-state manager 142, and a back bias generator 143. In typical configurations, the BIOS 120 is disposed in a memory that is coupled to the integrated circuit upon which the CPU 140 is disposed via a bus BIOSBUS. In addition, the VRM 130 is coupled to the CPU integrated circuit 140 via a bus VRMBUS. The C-state manager 141 generates buses CLKCTRL and FREQCTRL, which are routed to clock and frequency control circuits (not shown) in the CPU 140. Likewise, the P-state manager 142 generates buses VCTRL and FCTRL, which are routed to voltage and frequency control circuits (not shown) in the CPU 140. The back bias generator 143 produces an output FXDBIAS, which is coupled to the substrate 144.

In operation, the back bias generator 143 generates a fixed back bias voltage that is transmitted to the substrate 144 via voltage bus FXDBIAS in order to mitigate leakage in the CPU integrated circuit 140. As one skilled in the art will appreciate, back biasing a substrate 144 is one of the known techniques for decreasing the amount of leakage current in CMOS devices. For example, consider a CPU 140 (or other integrated circuit) of, say, 65 nm CMOS technology. This fabrication technology exhibits increased leakage of devices due to the shorter channel lengths that are employed over that of, say, a CPU produced by a 90 nm fabrication process. As a result, a 65 nm CPU 140 may exhibit an Ion-to-Ioff ratio of around 1,000, which is suboptimum in terms of leakage. Roughly one third of the device's power consumption may be due to leakage. A more desirable ratio is around 10,000. In addition to the ratio metric, many designers simply measure the power consumed by the device 140 when it is in a sleep state, for this is simply drain on a battery or other power source for which there is no meaningful return.

Accordingly, designers employ substrate back biasing as one mechanism to reduce the leakage of these smaller devices. In a typical 65 nm CPU 140, the back bias generator 143 produces a back bias voltage of, say, −500 mV, that is provided to the substrate 144 via bus FXDBIAS. This value is fixed at −500 mV and significantly decreases the amount of leakage exhibited by the device 140. However, as one skilled in the art will appreciate, while such a back bias value may be optimum for a given operating voltage (e.g., a 1 V core voltage provided by the VRM 130 over VRMBUS), when the core operating voltage changes (e.g., to, say, 600 mV), this fixed back bias value may not be the best choice from a performance standpoint, for it is well known that increasing the back bias voltage for a giving operating voltage serves to slow down switching times, thus decreasing overall performance of a device 140. In addition, for a fixed back bias, the amount of leakage exponentially decreases as operating voltage is decreased. This case is illustrated in the diagram 100.

ACPI is a standardized technique used in the art to optimize the power that is consumed by computers. Originally targeted toward extending the battery life of laptop computers, ACPI provides for various CPU states (i.e., C-states) that allow the CPU 140 to go into sleep, hibernation, or standby modes, thus incrementally reducing power consumption from that consumed by the CPU 140 in a full operational state. Typically, the definition of these C-states is programmed into the BIOS 120 and, generally, a user (not shown) may provide a stimulus (e.g., a keystroke, a mouse click, a button activation) through the user interface 101 to indicate to the operating system 102 that a particular C-state is to be entered or exited. In turn, the policy manager 103 consults the ACPI subsystem 105 to determine how the user input should affect the power state of the system based upon programming in the BIOS. As one skilled in the art will appreciate, C-states are one aspect of a global power management scheme provided via ACPI that is directed at managing power consumed by a CPU 140. Other aspects are directed towards power management in other devices such as memory, peripheral buses, etc. It is beyond the scope of this application to provide a comprehensive overview of this power management techniques. It is sufficient herein to note that a modern day computing system such as that shown in FIG. 1 employs techniques that dynamically change how a CPU 140 or similar device utilizes power therein in order to optimize system parameters such as performance, heat dissipation, and power consumption.

If the policy manager 103 determines that the CPU should enter a new C-state, then direction is provided to appropriate device drivers 104, which inform the ACPI hardware 110 via known mechanisms to change C-states. For example, a present day CPU 140 may have four or five C-states. In a typical CPU 140, the following C-states are defined:
C0—Normal Operating Mode
C1—Halt
C2—Stop Grant
C3—Shut off All Clocks
C4—Shut Off All Clocks and Reduce Voltage
C5—Shut Off All Clocks, Reduce Voltage, and Clear All Caches

As is clear from the state descriptions, the CPU 140 will exhibit a decreasing amount of power consumption as the states transition from C0 though C5. This direction is provided by the operating system 102 to the ACPI hardware 110. Consequently, the VRM 130 will increase or reduce the operating voltage provided to the CPU 140 as a function of C-state, and the C-state manager 141 will turn off/turn on clocks to various internal logic elements (not shown) such as on-board caches, snoop logic, bus logic, etc. If a particular C-state calls for a voltage change, the C-state manager 141 will provide for a corresponding change in core operating frequency via FREQCTRL that is commensurate with the new operating voltage.

The operating parameters within each of the C-states may also be dynamically managed as a function of programming in the BIOS 120, generally in terms of how fast the CPU 140 runs. For instance, a present day CPU 140 also provides for a number of performance states (i.e., P-states). These performance states range from high end performance at max operating frequency and voltage and incrementally decrease to minimum operating frequency at minimum operating voltage. In a 65 nm process CPU 140, the high end performance state, P0, may be 3.6 GHz core clock frequency at 1 V core voltage, and the minimum performance state, P5, may be 800 MHz core clock frequency at 600 mV core voltage. Typically, the number and operating points of these P-states are programmed into the BIOS 120 and are controlled by the operating system 102. As with C-states, when a P-state change is directed, such information is communicated to the ACPI hardware 110 from the operating system 102, and the VRM 130 changes the core operating voltage accordingly. In addition, the P-state manager 142 utilizes buses VCTRL and FCTRL to change the core operating frequency and associated core voltage to comport with the P-state that has been received.

Yet, as one skilled in the art will appreciate, when core operating voltage changes in the CPU 140, operating frequency is capped as a result of the difference between the core operating voltage and the fixed back bias voltage. Such is the balance that present day system designers seek to achieve. Generally, the fixed back bias voltage is prescribed to optimize leakage at maximum operating conditions (e.g., C0 and P0) and the remaining performance states are defined in BIOS 120 based upon that which is achievable when employing the fixed back bias voltage. For example, in a 65 nm CPU 140, the back bias voltage may be prescribed to be −500 mV in order to achieve an Ion-to- Ioff ratio of 10,000 at a 1 V core voltage when operating at 3.6 GHz. Because the back bias voltage is fixed, when core voltage is dropped to 600 mV, the Ion-to-Ioff ratio may exceed 1,000,000 and the maximum achievable operating frequency may only be 800 MHz.

The present inventor has noted that systems configured in the way described above, specifically CPUs 140 that are configured to provide a fixed back bias voltage, are limited in terms of overall performance flexibility. That is, the present inventor has observed conditions under which a CPU that provides for sufficient leakage mitigation at full performance suffers for constrained performance a lower operating voltages. This is because the fixed back bias voltage at lower core voltages overcompensates for leakage and as a result operating frequency is constrained based upon the differential voltage between core operating voltage and the fixed bias voltage. Accordingly, the present inventor contemplates that it is desirable to provide for dynamic management and control of back bias voltage as a function of the parameters associated with ACPI, that is, C-states and P-states.

Accordingly, the present invention provides for such control, thus allowing back bias voltage to be dynamically managed on chip, thus enabling a CPU or processor operating at a lower core voltage to run faster, while still maintaining sufficient leakage mitigation. In one embodiment, an apparatus and method are provided that allow granular table-based back bias values to be accessed and generated as a function of C-state and P-state. Another embodiment contemplates an apparatus and method that utilizes a formulaic technique to determine and generate a back bias voltage value based upon current C-state and P-state. Yet anther embodiment comprehends an adjustable apparatus for adaptive back bias voltage determination and generation that is programmable at the device level. The present invention will now be described with reference to FIGS. 2-4.

Turning to FIG. 2, a block diagram is presented depicting an apparatus for selective back bias control in an integrated circuit 200 according to the present invention. The apparatus is configured to be disposed within an integrated circuit 200 that employs ACPI techniques for power management, such as the CPU 140 of FIG. 1, however other embodiments are contemplated. The integrated circuit (IC) 200 includes a C-state manager 201 that receives a C-state communication via bus C-STATE and which generates buses CLKCTRL and FREQCTRL, which are routed to clock and frequency control circuits (not shown) in the integrated circuit 200. Likewise, a P-state manager 202 receives a P-state communication via bus P-STATE, and generates buses VCTRL and FCTRL, which are routed to voltage and frequency control circuits (not shown) in the IC 200.

In contrast to a present day integrated circuit, such as the CPU 140 of FIG. 1, the IC 200 according to the present invention also has state table logic 203 and a selective bias generator 204. The state table logic 203 receives buses C-STATE and P-STATE and generates a back bias indication, which is transmitted to the selective bias generator 204 via bus BIASSEL. The selective bias generator 204 produces an output FXDBIAS, which is coupled to a substrate 205, substantially similar to the substrate 144 of FIG. 1. In an embodiment where the IC 200 is configured as a CPU, the state table logic 203 according to the present invention is configured to store a fixed number of back bias voltage indications that are indexed as a function of both C-state and P-state. The state table logic 203 comprises logic, circuits, devices, or microcode (i.e., micro instructions or native instructions), or a combination of logic, circuits, devices, or microcode, or equivalent elements that are employed to store the fixed number of back bias voltage indications according to the present invention. The elements employed to store the indications within the state table 203 may be shared with other circuits, microcode, etc., that are employed to perform other functions within the IC 200. According to the scope of the present application, microcode is a term employed to refer to one or more micro instructions. A micro instruction (also referred to as a native instruction) is an instruction at the level that a unit executes. For example, micro instructions are directly executed by a reduced instruction set computer (RISC). For a complex instruction set computer (CISC) such as an x86-compatible microprocessor, x86 instructions are translated into associated micro instructions, and the associated micro instructions are directly executed by a unit or units within the CISC.

Likewise, the selective bias generator 204 is configured to receive a bias indication via bus BIASSEL and to generate and distribute a corresponding back bias voltage via bus BACKBIAS to the substrate 205. The selective bias generator 204 comprises logic, circuits, devices, or microcode (i.e., micro instructions or native instructions), or a combination of logic, circuits, devices, or microcode, or equivalent elements that are employed to generate and distribute the fixed number of back bias voltages according to the present invention. The elements employed to generate and distribute the back bias voltages may be shared with other circuits, microcode, etc., that are employed to perform other functions within the IC 200.

In operation, ACPI C-state and P-state control information is received from an operating system via device drivers as in FIG. 1 over buses C-STATE and P-STATE. In contrast to a present day integrated circuit that generates only a fixed back bias voltage, the apparatus according to the present invention comprises a plurality of back bias voltage indications that are stored or otherwise programmed into the state table logic 203 and that are accessed based upon the values of busses C-STATE and P-STATE. In one embodiment, the state table logic 203 comprises a programmable read-only memory. Another embodiment contemplates a flash memory or other form of non-volatile computer storage technology that can be electrically erased and reprogrammed. One embodiment contemplates a state table 203 capable of storing up to 64 value indications, thus allowing for storage of back bias indications corresponding to at most eight C-states and eight P-states. Since the present invention provides for a plurality of indications, the mapping of C-state and P-state to bias indication is configurable.

As C-state and P-state changes, the bias indication is provided to the selectable bias generator 204, which generates and distributes to the substrate 205 a selected back bias voltage that is commensurate with the current power and performance states of the IC 200. In one embodiment, the selective bias generator 204 generates and distributes both positive and negative back bias voltages, thus allowing operating frequency to be maximized at lower operating voltages. Consequently, a designer is allowed to maintain, say, a fixed Ion-to-Ioff ratio at all core operating voltages, while maximizing operating frequency. Also, the designer may opt to maintain a fixed draw on a power source as various logic blocks or other resources in the IC 200 are turned off as a function of C-state. The selective back bias apparatus described herein is very configurable, thus allowing many performance parameters to be optimized as function of dynamic control of back bias voltage. For example, it may be desirable in some environments to overclock the IC by raising the back bias voltage. While leakage is increased, performance (e.g., operating frequency) of the IC 200 can be increased as well. The configuration described above lends itself very well to such configurations.

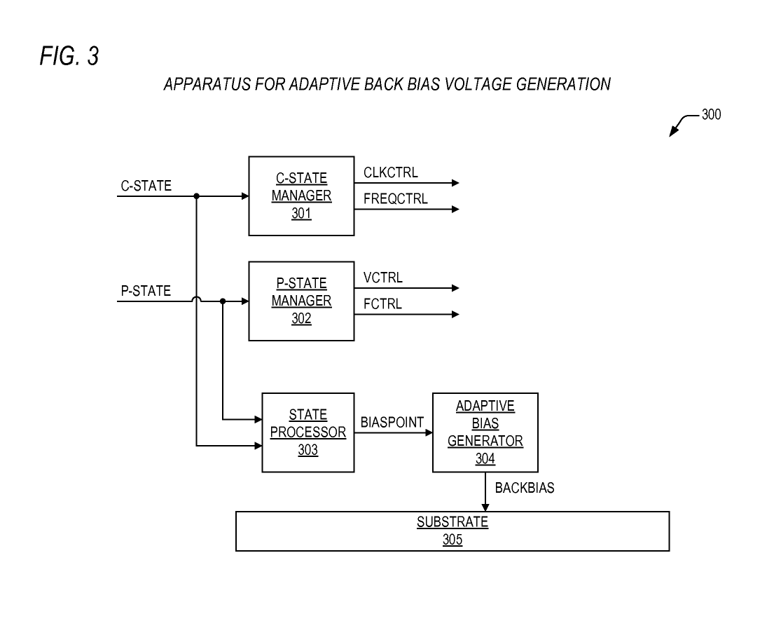

Now referring to FIG. 3, a block diagram is presented depicting an apparatus for adaptive back bias control in an integrated circuit 300 according to the present invention. The apparatus is configured to be disposed within an integrated circuit 300 that employs ACPI techniques for power management, such as the CPU 140 of FIG. 1, however other embodiments are contemplated. The integrated circuit (IC) 300 includes a C-state manager 301 that receives a C-state communication via bus C-STATE and which generates buses CLKCTRL and FREQCTRL, which are routed to clock and frequency control circuits (not shown) in the integrated circuit 300. Likewise, a P-state manager 302 receives a P-state communication via bus P-STATE, and generates buses VCTRL and FCTRL, which are routed to voltage and frequency control circuits (not shown) in the IC 300.

The IC 300 also has a state processor 303 and an adaptive bias generator 304. The state processor 303 receives buses C-STATE and P-STATE and generates a back bias indication, which is transmitted to the adaptive bias generator 304 via bus BIASPOINT. The adaptive bias generator 304 produces an output BACKBIAS, which is coupled to a substrate 305, substantially similar to the substrate 144 of FIG. 1. In an embodiment where the IC 300 is configured as a CPU, the state processor 303 according to the present invention is configured to generate variable bias indications that are a function of both C-state and P-state. In one embodiment, the state processor 303 performs an interpolation to determine the value of BIASPOINT based upon the values of C-STATE and P-STATE which ranges between a minimum and maximum back bias voltage. In one embodiment, the interpolation is linear. Another embodiment contemplates a quadratic interpolation. A further embodiment performs a weighted interpolation between the minimum and maximum back bias values where weights are assigned to favor P-state and C-state as a function of design goals. The state processor 303 comprises logic, circuits, devices, or microcode (i.e., micro instructions or native instructions), or a combination of logic, circuits, devices, or microcode, or equivalent elements that are employed to generate the variable back bias voltage indications according to the present invention. The elements employed to generate the indications within the state processor 303 may be shared with other circuits, microcode, etc., that are employed to perform other functions within the IC 300.

Likewise, the adaptive bias generator 304 is configured to receive bias indication via bus BIASPOINT and to generate and distribute a corresponding back bias voltage via bus BACKBIAS to the substrate 305. The adaptive bias generator 304 comprises logic, circuits, devices, or microcode (i.e., micro instructions or native instructions), or a combination of logic, circuits, devices, or microcode, or equivalent elements that are employed to generate and distribute the variable number of back bias voltages according to the present invention. The elements employed to generate and distribute the back bias voltages may be shared with other circuits, microcode, etc., that are employed to perform other functions within the IC 300.

In operation, ACPI C-state and P-state control information is received from an operating system via device drivers as in FIG. 1 over buses C-STATE and P-STATE. In contrast to a present day integrated circuit that generates only a fixed back bias voltage, the apparatus according to the present invention comprises a plurality of back bias voltage indications that are generated by the state processor 303 as described above based upon the values of busses C-STATE and P-STATE. In one embodiment, the number of variable bias voltage indications is limited by the size of bus BIASPOINT. An 8-bit BIASPOINT bus is contemplated in one embodiment, thus allowing for prescription of up to 256 separate back bias voltage indications, which need not be necessarily linear.

As C-state and P-state changes, the bias indication is provided to the adaptive bias generator 304, which generates and distributes to the substrate 305 a back bias voltage that is commensurate with the current power and performance states of the IC 300. In one embodiment, the adaptive bias generator 304 generates and distributes both positive and negative back bias voltages, thus allowing operating frequency to be maximized at lower operating voltages. Consequently, a designer is allowed to maintain, say, a fixed Ion-to-Ioff ratio at all core operating voltages, while maximizing operating frequency. Also, the designer may opt to maintain a fixed draw on a power source as various logic blocks or other resources in the IC 300 are turned off as a function of C-state. The selective back bias apparatus described herein is very configurable, thus allowing many performance parameters to be optimized as function of dynamic control of back bias voltage. For example, it may be desirable in some environments to overclock the IC by raising the back bias voltage. While leakage is increased, performance (e.g., operating frequency) of the IC 200 can be increased as well. The configuration described above lends itself very well to such configurations.

In the weighted embodiment of FIG. 3, it is noted that since weighting of the various C-state and P-state values is fixed for interpolative purposes, it is desirable to allow for easy modification of these weighting values.

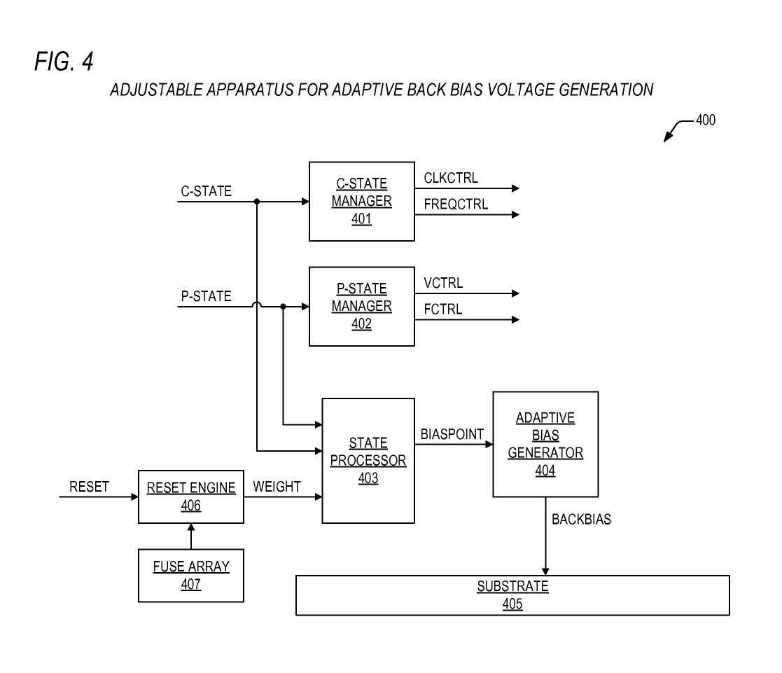

Accordingly, attention is now directed to FIG. 4, where a block diagram is presented featuring an adjustable apparatus for adaptive back bias control in an integrated circuit 400 according to the present invention. The apparatus is configured to be disposed within an integrated circuit 400 that employs ACPI techniques for power management, such as the CPU 140 of FIG. 1, however other embodiments are contemplated. The integrated circuit (IC) 400 includes a C-state manager 401 that receives a C-state communication via bus C-STATE and which generates buses CLKCTRL and FREQCTRL, which are routed to clock and frequency control circuits (not shown) in the integrated circuit 400. Likewise, a P-state manager 402 receives a P-state communication via bus P-STATE, and generates buses VCTRL and FCTRL, which are routed to voltage and frequency control circuits (not shown) in the IC 400.

The IC 300 also has a state processor 403 and an adaptive bias generator 404. The state processor 303 receives buses C-STATE and P-STATE and generates a back bias indication, which is transmitted to the adaptive bias generator 404 via bus BIASPOINT. The adaptive bias generator 404 produces an output BACKBIAS, which is coupled to a substrate 405, substantially similar to the substrate 144 of FIG. 1. In an embodiment where the IC 400 is configured as a CPU, the state processor 403 according to the present invention is configured to generate variable bias indications that are weighted as a function of both C-state and P-state as is described in like-named elements discussed with reference to the weighted embodiment of FIG. 3. The state processor 403 comprises logic, circuits, devices, or microcode (i.e., micro instructions or native instructions), or a combination of logic, circuits, devices, or microcode, or equivalent elements that are employed to generate the variable back bias voltage indications according to the present invention. The elements employed to generate the indications within the state processor 403 may be shared with other circuits, microcode, etc., that are employed to perform other functions within the IC 400.

Likewise, the adaptive bias generator 404 is configured to receive bias indication via bus BIASPOINT and to generate and distribute a corresponding back bias voltage via bus BACKBIAS to the substrate 305. The adaptive bias generator 404 comprises logic, circuits, devices, or microcode (i.e., micro instructions or native instructions), or a combination of logic, circuits, devices, or microcode, or equivalent elements that are employed to generate and distribute the variable number of back bias voltages according to the present invention. The elements employed to generate and distribute the back bias voltages may be shared with other circuits, microcode, etc., that are employed to perform other functions within the IC 400.

The IC 400 also includes a fuse array 407 that is coupled to a reset engine 406. The fuse array 407 comprises one or more polymer or metal fuses that are disposed upon layers of a die upon which the integrated circuit 400 is fabricated. Selected fuses within fuse array 407 are configured to be blown during fabrication and test by known means in order to assign/modify the weighting giving to C-states and P-states during the interpolative process associated with determination of the value of BIASPOINT. In one embodiment, the fuses are blown to assign the weighting values. In another embodiment, default weighting values are provided by the state processor 403 and the fuse array values are blown to override those default values.

The resent engine 406 is configured to receive a reset signal. As part of a reset sequence in the IC 400, the reset engine 406 reads the states of the selected fuses in the fuse array 407 and communicates corresponding weighting values to the state processor 403 via bus WEIGHT, thus providing a mechanism to assign and/or override default weightings for interpolation of the back bias voltage indication as a function of C-state and P-state values.

In operation, the selected fuses are blown during fabrication and test of the IC 400. Upon reset, the reset engine 406 reads the state of the fuse array 407 and communicates the corresponding weightings to the state processor 403 via WEIGHT. ACPI C-state and P-state control information is received from an operating system via device drivers as in FIG. 1 over buses C-STATE and P-STATE. The apparatus according to the present invention comprises a plurality of back bias voltage indications that are generated by the state processor 403 as described above based upon the values of busses C-STATE and P-STATE. In one embodiment, the number of variable bias voltage indications is limited by the size of bus BIASPOINT. An 8-bit BIASPOINT bus is contemplated in one embodiment, thus allowing for prescription of up to 256 separate back bias voltage indications, which need not be necessarily linear.

As C-state and P-state changes, the bias indication is provided to the adaptive bias generator 404, which generates and distributes to the substrate 405 a back bias voltage that is commensurate with the current power and performance states of the IC 400. In one embodiment, the adaptive bias generator 304 generates and distributes both positive and negative back bias voltages, thus allowing operating frequency to be maximized at lower operating voltages. Consequently, a designer is allowed to maintain, say, a fixed Ion-to-Ioff ratio at all core operating voltages, while maximizing operating frequency, but is able to adjust that ratio at the wafer level through the use of the fuse array 407.

Those skilled in the art should appreciate that they can readily use the disclosed conception and specific embodiments as a basis for designing or modifying other structures for carrying out the same purposes of the present invention, and that various changes, substitutions and alterations can be made herein without departing from the scope of the invention as defined by the appended claims.

What is claimed is:

1. An apparatus for dynamically varying a bias voltage that is applied to a substrate of an integrated circuit, the apparatus comprising:
a selective bias generator, disposed on the integrated circuit, configured to generate one of a plurality of bias voltages according to a value received over a bias select bus, wherein said one of the plurality of bias voltages is applied to the substrate; and
state table logic, coupled to said selective bias generator, configured to receive one or more power management states, and configured to provide said value over said bias select bus, wherein said value comprises one of a plurality of bias indications stored within said state table logic.

2. The apparatus as recited in claim 1, wherein said one or more power management states comprise:
Advanced Configuration and Power Management Interface (ACPI) C-states, and wherein said value is varied responsive to said ACPI C-states.

3. The apparatus as recited in claim 2, wherein said one or more power management states further comprise
ACPI P-states, and wherein said value is varied responsive to said ACPI C-states and said ACPI P-states.

4. The apparatus as recited in claim 1, wherein said state table logic comprises a programmable read-only memory.

5. The apparatus as recited in claim 1, wherein a mapping of said power management states to said plurality of bias indications is configurable.

6. The apparatus as recited in claim 1, wherein said selective bias generator generates both negative and positive bias voltages.

7. The apparatus as recited in claim 1, wherein the apparatus varies the bias voltage applied to the substrate in order to increase operating frequency of the integrated circuit at the expense of increased leakage.

8. The apparatus as recited in claim 1, wherein the integrated circuit comprises a microprocessor.

9. An apparatus for dynamically varying a bias voltage that is applied to a substrate of an integrated circuit, the apparatus comprising:
a microprocessor, comprising:
a selective bias generator, disposed on the integrated circuit, configured to generate one of a plurality of bias voltages according to a value received over a bias select bus, wherein said one of the plurality of bias voltages is applied to the substrate; and
state table logic, coupled to said selective bias generator, configured to receive one or more power management states, and configured to provide said value over said bias select bus, wherein said value comprises one of a plurality of bias indications stored within said state table logic.

10. The apparatus as recited in claim 9, wherein said one or more power management states comprise:
Advanced Configuration and Power Management Interface (ACPI) C-states, and wherein said value is varied responsive to said ACPI C-states.

11. The apparatus as recited in claim 10, wherein said one or more power management states further comprise:
ACPI P-states, and wherein said value is varied responsive to said ACPI C-states and said ACPI P-states.

12. The apparatus as recited in claim 9, wherein said state table logic comprises a programmable read-only memory.

13. The apparatus as recited in claim 9, wherein a mapping of said power management states to said plurality of bias indications is configurable.

14. The apparatus as recited in claim 9, wherein said selective bias generator generates both negative and positive bias voltages.

15. The apparatus as recited in claim 9, wherein the apparatus varies the bias voltage applied to the substrate in order to increase operating frequency of the integrated circuit at the expense of increased leakage.

16. A method for dynamically varying a bias voltage that is applied to a substrate of an integrated circuit, the method comprising:
storing a plurality of bias indications within state table logic disposed on the integrated circuit;
via the state table logic, receiving one or more power management states, and providing a value over a bias select bus, wherein the value comprises one of the plurality of bias indications; and
via a selective bias generator disposed on the integrated circuit, receiving the value over the bias select bus, generating one of a plurality of bias voltages according to the value, and applying the one of the plurality of bias voltages to the substrate.

17. The method as recited in claim 16, wherein the one or more power management states comprise:
Advanced Configuration and Power Management Interface (ACPI) C-states, and wherein the value is varied responsive to the ACPI C-states.

18. The method as recited in claim 17, wherein the one or more power management states further comprise:
ACPI P-states, and wherein the value is varied responsive to the ACPI C-states and the ACPI P-states.

19. The method as recited in claim 16, wherein the state table logic comprises a programmable read-only memory.

20. The method as recited in claim 16, wherein the selective bias generator generates both negative and positive bias voltages.

21. The method as recited in claim 16, wherein the method varies the bias voltage applied to the substrate in order to increase operating frequency of the integrated circuit at the expense of increased leakage.
